(19) United States
(12) Patent Application Publication
(10) Pub. No.: US 2024/0274334 A1
(43) Pub. Date: Aug. 15, 2024

(54) R-T-B MAGNET AND PREPARATION METHOD THEREOF

(71) Applicants: BEIJING ZHONG KE SAN HUAN HI-TECH CO., LTD., Beijing (CN); NINGBO KONIT INDUSTRIES INC., Ningbo (CN)

(72) Inventors: Fangyun WEI, Beijing (CN); Dengxing WANG, Beijing (CN); Wei ZHU, Beijing (CN); Fei DU, Beijing (CN); Die HU, Beijing (CN)

(21) Appl. No.: 18/646,245

(22) Filed: Apr. 25, 2024

Related U.S. Application Data
(63) Continuation of application No. PCT/CN2023/082340, filed on Mar. 17, 2023.

(30) Foreign Application Priority Data
Mar. 18, 2022 (CN) 202210271193.9

(51) Int. Cl. H01F 1/057; B22F 3/16; B22F 9/04; H01F 41/02

(52) U.S. Cl. CPC H01F 1/0577; B22F 3/16; B22F 9/04; H01F 41/0253; B22F 2009/044; B22F 2201/20; B22F 2202/05; B22F 2998/10

(57) ABSTRACT

A magnet with an elemental composition of R1ₓR2_{y}T_{1-x-y-z-u-a-b-c}B_{z}TiᵤCuₐGa_{b}A_{c}. R1 is a light rare earth element, and the light rare earth element includes at least one of Pr or Nd, R2 is a heavy rare earth element including at least one of Dy or Tb, T includes Fe and Co, A includes at least one of Al, Nb, Zr, Sn, or Mn, and x, y, z, u, a, b, and c are mass percentages and satisfy: 28%≤x+y≤30.5%, 0.88%≤z≤0.92%, 0.12%≤u≤0.15%, 0≤a≤0.15%, 0.15%≤b≤0.25%, and 0≤c≤2%.

### CROSS-REFERENCE TO RELATED APPLICATION

This application is a continuation of International Application No. PCT/CN2023/082340, filed Mar. 17, 2023, which claims priority to Chinese Application No. 202210271193.9, filed Mar. 18, 2022, the entire contents of both of which are incorporated herein by reference.

### TECHNICAL FIELD

The present disclosure relates to rare earth permanent magnet, in particular to an R-T-B magnet and a preparation method thereof.

### BACKGROUND

Neodymium iron boron (NdFeB) magnets are currently considered as essential functional materials for energy saving and performance improvement, and the range of application and production thereof is expanding year by year. Due to the usage of magnets at high-temperature, it is required to produce NdFeB magnets having high remanence and high coercivity. Moreover, since the coercivity of a magnet tends to significantly decrease as the operating temperature rises, it is needed to improve the coercivity at room temperature enough in order to maintain the corresponding coercivity at operating temperatures.

One method to improve the coercivity of NdFeB magnets is through the partial substitution of Nd in the main phase Nd2Fe14B compound with Dy or Tb. However, Dy and Tb resources are limited with high and unstable prices. Therefore, it is needed to develop a new process and composition for R—Fe—B magnets with high coercivity and high remanence, including minimizing the content of Dy and Tb to the greatest extent possible.

Chinese patent publication CN106024235 discloses an R-T-B sintered magnet and its composition, wherein the content of Ga ranges from 0.3 mass % to 0.8 mass %, the content of B ranges from 0.8 mass % to 0.92 mass %, the content of Al ranges from 0.05 mass % to 0.5 mass %, the content of Ti ranges from 0.15 mass % to 0.29 mass %, and the content of C ranges from 0.10 mass % to 0.30 mass %. Due to the lower B content compared with conventional R-T-B sintered magnets and the addition of Ga, the formation of the R2T17 phase is suppressed, and the R-T-Ga phase is generated, which resulted in a high HcJ (intrinsic coercivity). The patent publication also points out that when the content of Ti is less than 0.15 mass %, the fluctuation in HcJ is easily caused by the change in B amount, and when the content of Ga is less than 0.3 mass %, the formation of the R-T-Ga phase is insufficient, and the R2T17 phase cannot be eliminated, so that the magnet with high HcJ cannot be obtained.

### SUMMARY

The purpose of this disclosure is to provide a magnet with high remanence and high coercivity while suppressing coercivity fluctuations.

In order to achieve the above object, a first aspect of the disclosure provides an R-T-B magnet having elemental composition of R1ₓR2_{y}T_{1-x-y-z-u-a-b-c}B_{z}TiᵤCuₐGa_{b}A_{c}, wherein R1 represents light rare earth elements, including at least one of Pr or Nd; R2 represents heavy rare earth elements, including at least one of Dy or Tb; T includes Fe and Co; A includes at least one element selected from the group consisting of Al, Nb, Zr, Sn and Mn; wherein x, y, z, u, a, b and c are mass percentages and satisfy 28%≤x+y≤30.5%, 0.88%≤z≤0.92%, 0.12%≤u≤0.15%, 0≤a≤0.15%, 0.15%≤b≤0.25%, 0≤c≤2%.

Optionally, in the R-T-B magnet, the mass percentage of Cu is in a range of 0.12 mass % to 0.15 mass %, the mass percentage of Co is in a range of 0.5 mass % to 2.5 mass %; in some embodiments, the mass percentage of the heavy rare earth element (R2) is lower than 2 mass %.

Optionally, the R-T-B magnet comprises a main phase and a grain boundary phase, wherein the grain boundary phase comprises an R-T-M-Ti phase, and the R-T-M-Ti phase comprises a delt-like phase, wherein the area of the R-T-M-Ti phase accounts for 20 to 30% of the area of the grain boundary phase, and the area of the delt-like phase with R/T ratio in the range of 0.2 to 0.46 accounts for 40% to 50% of the area of the R-T-M-Ti phase.

Optionally, the R-T-M-Ti phase is represented by the formula R3ₘR4ₙT_{1-M-n-v-e}MᵥTiₑ, wherein R3 is selected from Pr and/or Nd, R4 is selected from Dy and/or Tb, M comprises Ga and/or other metal elements, other metal elements include Cu and/or A, A includes at least one element selected from the group consisting of Al, Nb, Zr, Sn and Mn, T includes at least one of Fe or Co; m, n, v and e which are in atomic percentages respectively satisfy: 14%≤m+n≤60%, 0.1%≤v≤11%, 0.01%≤e≤9%.

Optionally, in the delt-like phase, the content of R3 and R4 combined is in a range of 18 at % to 29 at %, the content of T is in a range of 59 at % to 74 at %, the content of M is in a range of 0.01 at % to 5 at %, and the content of Ti is more than 1 at %.

Optionally, the grain boundary phase area with Ga/M greater than 70% accounts for 60% to 65% of the R-T-M-Ti phase area.

A second aspect of the disclosure provides a method of preparing the R-T-B magnet, comprising:
Melting and casting the alloy raw materials with the elemental composition described above in a vacuum induction furnace to obtain alloy strip;
Coarsely grinding the alloy strip by performing hydrogen decrepitation, and then fine grinding by performing jet milling to obtain alloy fine powder;
Compacting the alloy fine powder in a magnetic field, and then sintering and performing aging treatment in a vacuum environment.

Optionally, the grain size of the alloy fine powder is in a range of 3.2 μm to 4.2 μm.

Optionally, in the melting and casting process, the vacuum degree of the vacuum induction furnace is in a range of 10⁻² Pa to 10⁻¹ Pa, the melting temperature is in a range of 1300° C. to 1500° C., and the melting time is in a range of 30 min to 60 min; the casting temperature is in a range of 1400° C. to 1500° C., and the casting time is in a range of 10 min to 15 min;

in the hydrogen decrepitation process, the hydrogen absorption pressure is in a range of 0.3 MPa to 0.4 MPa, and the dehydrogenation temperature is in a range of 560° C. to 600° C.;
in the fine grinding by jet milling process, the pressure of the jet mill chamber is in a range of 0.5 MPa to 0.7 MPa;
in the sintering process, the sintering temperature is in a range of 1000° C. to 1100° C., and the sintering time is in a range of 5 h to 8.5 h;
in the aging process, the aging temperature is in a range of 400° C. to 500° C., and the aging time is in a range of 7.5 h to 8.5 h.

A third aspect of the disclosure provides an R-T-B magnet prepared by the above method, wherein the content of C in the R-T-B magnet is in a range of 600 ppm to 800 ppm.

Optionally, the content of O in the R-T-B magnet is in a range of 600 ppm to 1200 ppm, the content of N in the R-T-B magnet is in a range of 100 ppm to 300 ppm.

The disclosed technical solution of this disclosure solved the problem of high proportion of R₂T₁₇ phase by synergistically adding elements such as Ti, B, and Ga to generate a delt-like phase in the grain boundary phase, thereby imparting the magnet with high coercivity and remanence.

Additional features and advantages of the disclosure will be set forth in the detailed description which follows.

### BRIEF DESCRIPTION OF THE DRAWING

FIG. 1 is an SEM photograph of the magnet of embodiment 1 (points 1-4);

FIG. 2 is an SEM photograph of the magnet of embodiment 1 (points 5-8);

FIG. 3 is an SEM photograph of the magnet of embodiment 1 (points 9-10).

### DETAILED DESCRIPTION OF EMBODIMENTS

Specific embodiments of the disclosure are described in detail below. It should be understood that the detailed description and specific embodiments are given by way of illustration and explanation only, not limitation. The at % in this disclosure is shorthand for atom %, i.e., the proportion calculated in atomic content.

The first aspect of the disclosure provides an R-T-B magnet, wherein the elemental composition of the R-T-B magnet is as follows: R1ₓR2_{y}T_{1-x-y-z-u-a-b-c}B_{z}TiᵤCuₐGa_{b}A_{c}, where R1 represents light rare earth elements, including at least one of Pr or Nd; R2 represents heavy rare earth elements, including at least one of Dy or Tb; T includes Fe and Co; A includes at least one element selected from the group consisting of Al, Nb, Zr, Sn and Mn; the magnet composition satisfies equation below, wherein x, y, z, u, a, b and c are mass percentages, 28%≤x+y≤30.5%, 0.88%≤z≤0.92%, 0.12%≤u≤0.15%, 0≤a≤0.15%, 0.15%≤b≤0.25%, 0≤c≤2%.

In existing technologies, the high content of Ti leads to the formation of numerous high-strength, high-hardness TiB₂ or TiB compounds at the grain boundaries, which results in the low cutting efficiency during magnet machining processes. Therefore, it is needed to reduce the content of TiB₂ or TiB in the magnet to improve the cutting efficiency in mass cutting processing.

The significant fluctuations in HcJ resulting from minor variations in boron (B) content are attributed to changes in the proportion of R-T-Ga phases at the grain boundaries in the magnet. The formation of R-T-Ga phases is sensitive to the heat treatment temperature, and uneven heat treatment temperatures affect the formation proportion of R-T-Ga phases. This disclosure addresses the issue by adjusting the elemental composition of the R-T-B magnet through the synergistic addition of elements such as Ti, B, and Ga, effectively resolving the problem of high proportions of R₂T₁₇ phase and imparting the magnet with high coercivity and remanence.

In some embodiments, in the R-T-B magnet, the mass percentage of Cu element is in a range of 0.12% to 0.15%, and the mass percentage of Co element is in a range of 0.5% to 2.5%. Furthermore, in some embodiments, when the content of Dy and/or Tb is less than 2%, a magnet with excellent comprehensive performance, characterized by Br>13.8 kGs and HcJ>19.5 kOe, can be prepared.

In some embodiments, the R-T-B magnet comprises a main phase and a grain boundary phase, wherein the grain boundary phase comprises a R-T-M-Ti phase, and the R-T-M-Ti phase comprises a delt-like phase, wherein the area of the R-T-M-Ti phase accounts for 20% to 30% of the area of the grain boundary phase, and the area of the delt-like phase with R/T ratio in the range of 0.2 to 0.46 accounts for 40% to 50% of the area of the R-T-M-Ti phase.

Consistent with the disclosure, reducing the Ti and C content can improve the cutting efficiency of the magnet to a certain extent. Besides, Ti can substitute for Fe atoms in the main phase, and when the Ti content is high, there is a possibility of increased formation of the R₂T₁₇ phase, leading to a decrease in the magnet's coercivity (HcJ). Therefore, reducing the Ti content can decrease the precipitation of the R₂T₁₇ phase, thereby increasing HcJ and reducing HcJ fluctuations.

With a decrease in Ga content, HcJ can be improved. may be that although the generation of R-T-Ga phases decreases, analysis reveals a phase with a composition very close to R-T-Ga phase is formed in the magnet's grain boundaries, namely the R-T-M-Ti phase with Ti content exceeding 1 at % and R content relatively lower compared to R-T-Ga phases. Besides, the R-T-M-Ti phases includes delt-like phases. The inventors believe that the increase in HcJ may be due to Ti partially substituting for some R, resulting in more R-rich phase thin layers forming at the grain boundaries, increasing the spacing between grains and thereby improving HcJ.

Therefore, the disclosure solves the problem of high proportions of the R₂T₁₇ phase by synergistically adding elements such as Ti, B, Ga, leading to the formation of specific proportions of R-T-M-Ti phase and delt-like phase in the grain boundary phase, thereby imparting the magnet with high coercivity and remanence.

In a specific embodiment of the disclosure, the R-T-M-Ti phase represented by the formula R3ₘR4ₙT₁₋ₘ₋ₙ₋ᵥ₋ₑMᵥTiₑ, wherein R3 is selected from Pr and/or Nd, R4 is selected from Dy and/or Tb, M comprises Ga and/or other metal elements, the other metal elements include Cu and/or A, A is at least one element selected from the group consisting of Al, Nb, Zr, Sn and Mn, T includes Fe and Co; m, n, v and e are atomic percentages and satisfy: 14%≤m+n≤60%, 0.1%≤v≤11%, 0.01%≤e≤9%.

In some embodiments, in the delt-like phase, the content of R3+R4 is in a range of 18 at % to 29 at %, the content of T is in a range of 59 at % to 74 at %, the content of M is in a range of 0.01 at % to 5 at %, and the content of Ti is more than 1 at %.

In some embodiments, the grain boundary phase area with Ga/M ratio more than 70% accounts for 60% to 65% of the area of the R-T-M-Ti phase.

A second aspect of the disclosure provides a method preparing the R-T-B magnet, comprising:
Melting and casting the alloy raw materials with the elemental composition described above in a vacuum induction furnace to obtain alloy strip;
Coarsely grinding the alloy strip by performing hydrogen decrepitation, and then fine grinding by performing jet milling to obtain alloy fine powder;
Compacting the alloy fine powder in a magnetic field, and then sintering and performing aging treatment in a vacuum environment.

Optionally, the grain size of the alloy fine powder is in a range of 3.2 m to 4.2 m.

Optionally, in the melting and casting process, the vacuum degree of the vacuum induction furnace is in a range of 10⁻² Pa to 10⁻¹ Pa, the melting temperature is in a range of 1300° C. to 1500° C., and the melting time is in a range of 30 min to 60 min; the casting temperature is in a range of 1400° C. to 1500° C., and the casting time is in a range of 10 min to 15 min;
in the hydrogen decrepitation process, the hydrogen absorption pressure is in a range of 0.3 MPa to 0.4 MPa, and the dehydrogenation temperature is in a range of 560° C. to 600° C.;
in the fine grinding process by jet milling, the pressure of the jet mill chamber is in a range of 0.5 MPa to 0.7 MPa;
in the sintering process, the sintering temperature is in a range of 1000° C. to 1100° C., and the sintering time is in a range of 5 h to 8.5 h,
in the aging process, the aging temperature is in a range of 400° C. to 500° C., and the aging time is in a range of 7.5 h to 8.5 h.

A third aspect of the disclosure provides an R-T-B magnet prepared by the above method, wherein the content of C in the R-T-B magnet is in a range of 600 ppm to 800 ppm.

Optionally, the content of O in the R-T-B magnet is in a range of 600 ppm to 1200 ppm, the content of N in the R-T-B magnet is in a range of 100 ppm to 300 ppm.

The disclosure is further illustrated by the following embodiments, but is not to be construed as being limited thereby. The raw materials used in the embodiments are all available from commercial sources.

### Embodiment 1

The R-T-B magnet of the embodiment was obtained by the raw materials of the R-T-B magnet sequentially subjected to melting, casting, coarse grinding by hydrogen decrepitation, fine grinding, compacting, sintering and aging. The specific raw material ratios were detailed in Table 1.

A method for producing the R-T-B magnet includes the following steps:
(1) melting: melting was carried out in a high-frequency vacuum induction melting furnace with the vacuum degree of 7×10⁻² Pa at a melting temperature of 1400° C.;
(2) casting: alloy strip with the thickness of 0.28 mm was obtained by a rapid solidification process, and the casting temperature was 1450° C.;
(3) hydrogen decrepitation: after hydrogen absorption, dehydrogenation and cooling treatment, hydrogen absorption was conducted under a hydrogen gas pressure of 0.3 MPa. Dehydrogenation was carried out while gradually increasing the temperature under vacuum conditions, with a dehydrogenation temperature of 500° C.;
(4) fine grinding: fine grinding was conducted under a vacuum atmosphere using jet milling to obtain fine powder with a particle size of 3.5 m. The jet milling grinding chamber pressure is 0.68 MPa. After grinding, zinc stearate lubricant is added at a rate of 0.12% by weight of the powder;
(5) compacting was carried out in a certain magnetic field under nitrogen atmosphere;
(6) sintering: sintering was carried out under vacuum conditions at 1050° C. for 8 hours, followed by slow air cooling;
(7) aging: aging was carried out under vacuum conditions at 500° C. for 8.5 hours, followed by cooling to room temperature;

The magnet prepared in embodiment 1 was subjected to magnetic property test and microstructure analysis.

### Embodiment 2

The preparation method of the R-T-B magnet of the embodiment was the same as that of the embodiment 1, and the specific ratios of the raw materials were detailed in Table 1.

### Embodiment 3

The raw materials of the R-T-B magnet of this embodiment were divided into a main alloy and an auxiliary alloy, the composition of the main alloy was R1₂₉Fe_{67.99}B_{0.92}Ti_{0.14}Cu_{0.13}Ga_{0.12}Co_{1.62}, and the composition of the auxiliary alloy was R1₁₉Dy₁₀Fe_{68.64}B_{0.92}Ti_{0.14}Cu_{0.1}Ga_{0.2}Co₁ (R1 was Pr and Nd). After melting, casting, hydrogen decrepitation, and fine grinding of the main and auxiliary alloys separately, the main alloy powder and auxiliary alloy powder are mixed according to ratio of 4:1, and then went through compacting, sintering, and aging processes to obtain the R-T-B magnet in this embodiment.

### Comparative Embodiment 1

The preparation method of the R-T-B magnet of comparative embodiment 1 was the same as that of embodiment 1, and the specific raw material composition was shown in table 1, with the Ti content of 0.16 wt %.

### Comparative Embodiment 2

The preparation method of the R-T-B magnet of comparative embodiment 2 was the same as that of embodiment 2, and the specific raw material composition was shown in table 1, with the Ga content of 0.16 wt %.

TABLE 1

| | Sample number | | | | | | | | | |
|---|---|---|---|---|---|---|---|---|---|---|
| | PrNd/ | B/ | Dy/ | Tb/ | Co/ | Cu/ | Ga/ | Al/ | Ti/ | Fe/ |
| | wt % | wt % | wt % | wt % | wt % | wt % | wt % | wt % | wt % | wt % |
| Embodiment 1 | 29 | 0.9 | 1.5 | — | 1 | 0.1 | 0.25 | 0.03 | 0.12 | bal |
| Embodiment 2 | 28.3 | 0.92 | 0.7 | 1.3 | 1 | 0.15 | 0.25 | — | 0.14 | bal |
| Embodiment 3 | 27 | 0.92 | 2 | — | 1.5 | 0.12 | 0.2 | — | 0.14 | bal |
| Comparative | 29 | 0.9 | 1.5 | — | 1 | 0.1 | 0.25 | 0.03 | 0.16 | bal |
| Embodiment 1 | | | | | | | | | | |
| Comparative | 28.3 | 0.92 | 0.7 | 1.3 | 1 | 0.15 | 0.4 | — | 0.14 | bal |
| Embodiment 2 | | | | | | | | | | |

### Test 1

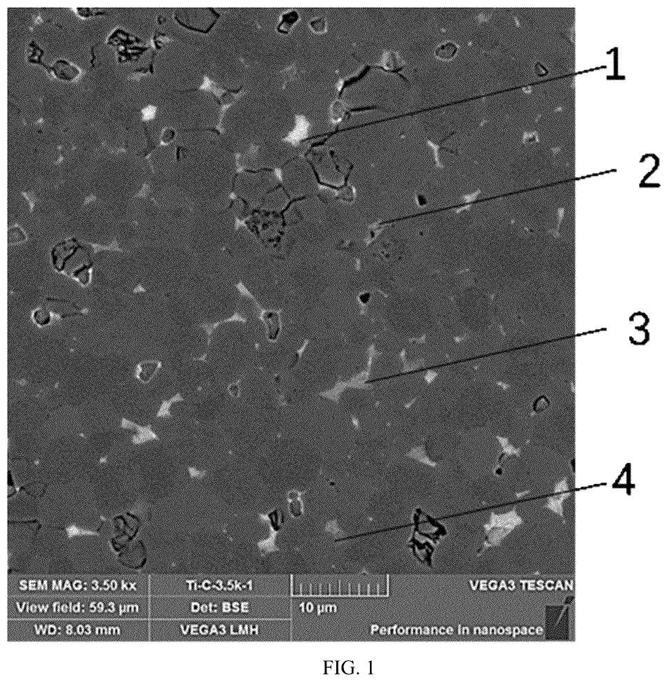

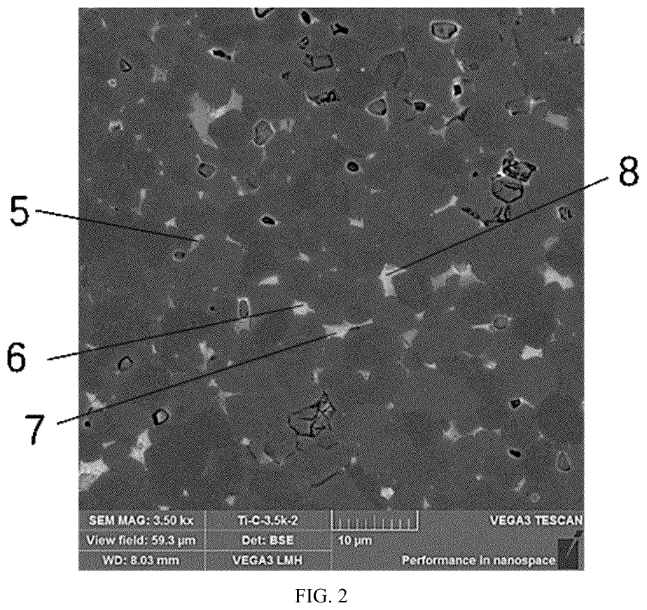

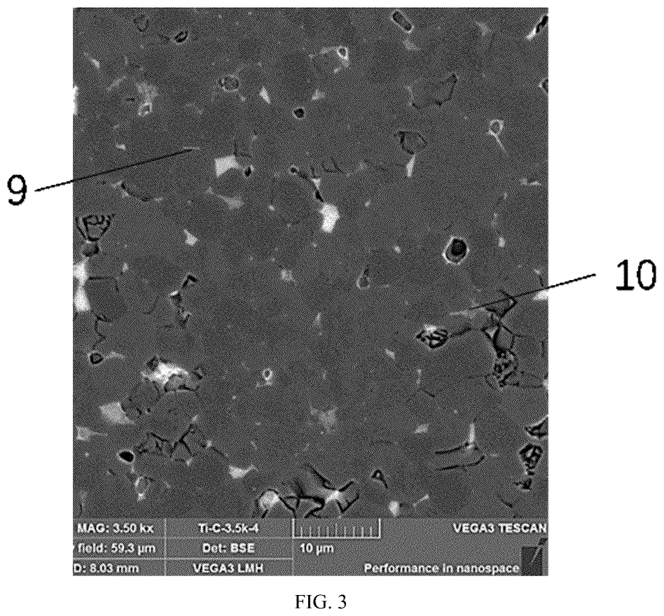

The microstructure of the R-T-B magnets prepared in the embodiment and the comparative ratio can be tested using scanning electron microscopy (SEM) analysis. This involves analyzing different views of the magnet using SEM and determining the elemental content in the grain boundary phases through point-by-point quantitative analysis. FIGS. 1 to 3 show the SEM images of the magnet in embodiment 1. By conducting elemental analysis, the phase in the triangular area between grains can be identified, and further calculations can be made to determine the area percentage of the phase. The elemental content at points 1 to 10 in embodiment 1 is presented in Table 2.

TABLE 2

| | Element | | | | | | | |
|---|---|---|---|---|---|---|---|---|
| | Ti/ | Fe/ | Co/ | Cu/ | Ga/ | Pr/ | Nd/ | Tb/ |
| | at % | at % | at % | at % | at % | at % | at % | at % |
| Point 1 | 0.87 | 78.88 | 1.64 | 0.28 | 0.03 | 3.84 | 10.39 | 0.43 |
| Point 2 | 1 | 47.57 | 0.32 | 0 | 0.22 | 16.79 | 30.12 | 0.56 |
| Point 3 | 0.26 | 54.76 | 0.96 | 0.4 | 2.57 | 10.68 | 27.55 | 1.2 |
| Point 4 | 2.03 | 58.36 | 1.06 | 0.55 | 1.1 | 8.6 | 18.07 | 0.42 |
| Point 5 | 1.75 | 70.48 | 1.13 | 0.25 | 1.84 | 5.03 | 12.61 | 0.66 |
| Point 6 | 0.14 | 55.85 | 1.34 | 0.27 | 2.44 | 10.58 | 27.15 | 0.61 |
| Point 7 | 0.05 | 40.98 | 3.51 | 1.57 | 0.05 | 16.33 | 34.89 | 1.25 |
| Point 8 | 0.05 | 39.08 | 0.33 | 0.04 | 0.15 | 19.63 | 38.08 | 1.47 |
| Point 9 | 0.09 | 58.7 | 0.47 | 0.06 | 0.19 | 11.68 | 22.14 | 0.77 |
| Point 10 | 2.57 | 43.16 | 4.48 | 5.47 | 2.29 | 11.27 | 22.74 | 0.32 |

In the magnet of embodiment 1, the R-T-M-Ti phase area accounts for 22.5% of the grain boundary phase area after analyzing the elemental content and area values of all grain boundary phases in the SEM images. For embodiment 2, the proportion of the R-T-M-Ti phase area in the grain boundary phase area is determined to be 26.1%. Besides, a delt-like phase is present in the grain boundary phase, and the grain boundary phases with R/T ratio ranging from 0.2 to 0.46 in the delt-like phase account for 47.5% of the R-T-M-Ti phase. In the R-T-M-Ti phase, the grain boundary phases with Ga/M ratios exceeding 70% account for 65% of the R-T-M-Ti phase.

In comparison, for the sintered magnet of the comparative embodiment 1, the area of R-T-M-Ti phases account for 16.7% of the area of grain boundary phase. Moreover, the grain boundary phases with R/T ratio ranging from 0.2 to 0.46 in the delt-like phase only account for 13.2% of the R-T-M-Ti phase.

### Test 2

The R-T-B magnets prepared in embodiments 1 to 3 underwent carbon content testing and magnetic performance testing. The specific magnetic performance testing method involved testing the residual induction (Br) and coercive force (HcJ) of the magnets at room temperature (20° C.) using a pulsed BH demagnetization curve testing equipment. The test results are shown in Table 3.

TABLE 3

| | | | the content of C |
|---|---|---|---|
| Sample number | Br (kGs) | H_{cJ} (kOe) | (ppm ) |
| Embodiment 1 | 14.05 | 19.5 | 650 |
| Embodiment 2 | 13.95 | 22.1 | 650 |
| Embodiment 3 | 14.20 | 19.6 | 750 |
| Comparative | 13.93 | 18.3 | 1000 |
| Embodiment 1 | | | |
| Comparative | 13.90 | 20.2 | 1200 |
| Embodiment 2 | | | |

The preparation method of the disclosed R-T-B magnets can impart magnets with high levels of residual induction and coercive force. A comparison between the embodiments and the comparative examples reveals that the magnets of embodiment 1, prepared with element contents falling within the disclosed ranges, exhibit higher residual induction and coercive force compared to comparative example 1. Further microscopic structural analysis reveals the presence of the R-T-M-Ti phase in the grain boundary phase of embodiment 1, with its proportion exceeding 20% of the grain boundary phase.

Comparing embodiment 1 with embodiment 2, it is evident that by generating a delt-like phase in the grain boundary phase and making grain boundary phases with R/T ratio ranging from 0.2 to 0.46 achieving a specific area ratio, the sum of magnetic energy density and coercive force of embodiment 2 surpasses that of embodiment 1, resulting in a magnet with superior comprehensive performance. Therefore, from the aforementioned embodiments and comparative examples, it is apparent that for magnets after prepared according to this disclosure, a specific area ratio of the delt-like phase is formed within the triangular region in the magnet grain boundary. The existence of this phase is a result of the synergistic addition of Ti, B, and Ga, combined with the corresponding production processes. This phase can effectively suppress the fluctuation of coercive force caused by a reduction of Ti content at specific amount of B. Furthermore, a decrease in Ga content inhibits the formation of the R₂T₁₇ phase, leading to a significant improvement in the coercive force of the sintered magnet.

Furthermore, the carbon (C) content in the magnets prepared from embodiments and comparative examples indicates that the C content in embodiments 1 to 3 ranges from 600 to 800 ppm, while the C content in magnets prepared from comparative examples 1 and 2 exceeds 900 ppm. After machining the magnets prepared from embodiment 1 and comparative example 1, it was observed that the wire cutting speed for embodiment 1 can reach up to 0.5 mm/min, whereas for the magnet prepared from comparative example 1, the wire cutting speed only reaches a maximum of 0.25 mm/min, resulting in lower cutting efficiency. Embodiment 1 not only achieves excellent magnetic performance but also demonstrates an improvement in cutting efficiency to a certain extent.

Some embodiments of the disclosure have been described above in detail, however, the disclosure is not limited to the specific details of the above embodiments, and various modifications may be made to the technical solution of the disclosure within the technical idea of the disclosure, and these modifications all belong to the protection scope of the disclosure.

It should be noted that, in the above embodiments, the various features described in the above embodiments may be combined in any suitable manner, and in order to avoid unnecessary repetition, various possible combinations will not be further described in the disclosure.

In addition, any combination of various embodiments of the disclosure may be made, and the same should be considered as the disclosure of the disclosure as long as it does not depart from the gist of the disclosure.

1. A magnet with an elemental composition of R1ₓR2_{y}T_{1-x-y-z-u-a-b-c}B_{z}TiᵤCuₐGa_{b}A_{c}, wherein:
R1 is a light rare earth element, and the light rare earth element includes at least one of Pr or Nd;
R2 is a heavy rare earth element including at least one of Dy or Tb;
T includes Fe and Co;
A includes at least one of Al, Nb, Zr, Sn, or Mn; and
x, y, z, u, a, b, and c are mass percentages and satisfy: 28%≤x+y≤30.5%, 0.88%≤z≤0.92%, 0.12%≤u≤0.15%, 0≤a≤0.15%, 0.15%≤b≤0.25%, and 0≤c≤2%.

2. The magnet according to claim 1, wherein a mass percentage of Cu is in a range of 0.12% to 0.15%, a mass percentage of Co is in a range of 0.5% to 2.5%.

3. The magnet according to claim 1, wherein a mass percentage of the heavy rare earth element R2 is lower than 2%.

4. The magnet according to claim 1, comprising a main phase and a grain boundary phase, wherein:
the grain boundary phase includes an R-T-M-Ti phase, and an area of the R-T-M-Ti phase accounts for 20% to 30% of an area of the grain boundary phase; and
an elemental composition of the R-T-M-Ti phase is R3ₘR4ₙT₁₋ₘ₋ₙ₋ᵥ₋ₑMᵥTiₑ, wherein:
R3 includes at least one of Pr or Nd, R4 includes at least one of Dy or Tb, M includes at least one of Ga, Cu, or A, A includes at least one of Al, Nb, Zr, Sn, or Mn, and T includes at least one of Fe or Co; and
m, n, v, and e are atomic percentages and satisfy: 14%≤m+n≤60%, 0.1%≤v≤11%, and 0.01%≤e≤9%.

5. The magnet according to claim 4, wherein in the R-T-M-Ti phase, the grain boundary phase with Ga/M of more than 70% accounts for 60% to 65% of the R-T-M-Ti phase.

6. A method of producing the magnet according to claim 1, comprising:
melting and casting an alloy raw material with the elemental composition of R1ₓR2_{y}T_{1-x-y-z-u-a-b-c}B_{z}TiᵤCuₐGa_{b}A_{c} in a vacuum induction furnace to obtain an alloy strip;
coarsely grinding the alloy strip by performing hydrogen decrepitation, and then fine grinding by performing jet milling, to obtain alloy fine powder;
compacting the alloy fine powder in a magnetic field, and then sintering and performing aging treatment in a vacuum environment.

7. The method according to claim 6, wherein:
in melting, a vacuum degree of the vacuum induction furnace is 10⁻² Pa to 10⁻¹ Pa, a melting temperature is 1300° C. to 1500° C., and a melting time is 30 min to 60 min; and
in casting, a casting temperature is 1400° C. to 1500° C., and a casting time is 10 min to 15 min;
a grain size of the alloy fine powder is 3.2 μm to 4.2 μm; and
conditions for the hydrogen decrepitation and grinding the alloy sheet include a hydrogen absorption pressure of 0.3 MPa to 0.4 MPa, a dehydrogenation temperature of 560° C. to 600° C., and a pressure of the jet mill chamber for fine grinding treatment being 0.5 MPa to 0.7 MPa; and
conditions for sintering include a sintering temperature of 1000° C. to 1100° C. and a sintering time of 5 h to 8.5 h, and conditions for the aging treatment include an aging temperature of 400° C. to 500° C. and an aging time of 7.5 h to 8.5 h.

8. A magnet produced by the method according to claim 6, wherein a content of C in the magnet is 600 ppm to 800 ppm.

9. The magnet according to claim 8, wherein a content of O in the magnet is 600 ppm to 1200 ppm, and a content of N in the magnet is 100 ppm to 300 ppm.
